(19) United States
(12) Patent Application Publication
(10) Pub. No.: US 2005/0177280 A1
(43) Pub. Date: Aug. 11, 2005

(54) Methods and systems for discovery of chemical compounds and their syntheses

(75) Inventors: Michael Almstetter, Ingolstadt (DE); Peter Zegar, Geretsried (DE); Andreas Tremi, Munchen (DE); Michael Thormann, Martinsried (DE); Lutz Weber, Germering (DE)

Correspondence Address: PALMER & DODGE, LLP;PAULA CAMPBELL EVANS, 111 HUNTINGTON AVENUE, BOSTON, MA, 02199, US

(73) Assignee: Morphochem Aktiengesellschaft fur Kombinatorische Chemie

(21) Appl. No.: 10/508,355

(22) PCT Filed: Mar. 24, 2003
(86) PCT No.: PCT/EP03/03054

Related U.S. Application Data
(60) Provisional application No. 60/366,548, filed on Mar. 22, 2002.

(51) Int. Cl. G05B 21/00

(52) U.S. Cl. 700/266

(57) ABSTRACT

A preferred embodiment of the present invention comprises method for planning the synthesis of one or more chemical compounds with specified chemical properties, comprising the steps of: (a) representing a space of synthesis plans, wherein each synthesis plan in the space of synthesis plans represents one or more vitual reaction schemas applied to one or more classes of virtual input reactants; (b) representing a space of virtual compounds, wherein each compound in the space of virtual compounds is a product of one or more of said synthesis plans; (c) constructing a first mapping from the space of virtual compounds to range space representing the desirability of a compound, wherein the first mapping is determined by one or more compound properties being measured; and (d) searching the space of synthesis plans for desirable compounds as represented in the range space.

### 1. Field of the Invention

The present invention relates to the discovery and development of new chemical compounds having pre-determined properties. More particularly, the present invention includes computer-implemented methods and computer systems for searching a generally-defined space of chemical compounds in order to discover those compounds or libraries and their way of synthesis with pre-determined computable properties.

### 2. BACKGROUND OF THE INVENTION

In the recent past there has been a tremendous explosion in biological and chemical knowledge. It is of course extraordinary well known that DNA sequences of entire genomes of many organisms have already been sequenced, and sequences of additional organisms are being completed at an increasingly rapid pace. Genome sequencing is now a well understood art. It is only somewhat less well known that corresponding advances have been made in the study of proteins. Tens of thousands of detailed protein structures have been determined and stored in database. This immense store of structural knowledge is now promoting increasing understanding of protein structure and function. See, e.g., Branden et al., 1999 (₂^{nd} ed.), Introduction to Protein Structure and Function, Garland Publishing, Inc., New York.

Similar strides have been made in chemistry. To name but a few recent advances, chemists can now routinely synthesize libraries of perhaps millions of individual compounds by fully automated combinatorial techniques. See, e.g., Weber, 2000, Current Opinion in Chemical Biology 4:295-302. Advances in understanding intricacies of compound structures and reaction mechanisms now allows synthesis of compounds of heretofore unheard of properties, for example, flexible, light-emitting organic polymers. These advances also allow increasingly accurate computation of compound structure, properties and interactions.

In addition, continuing advances in computational power and data storage resources enable routine calculations on work-station type computer systems that even a mere 15 years ago would have required what was then considered a supercomputer. Further, increasing communication bandwidth allows parallel systems to be constructed, locally and across the Internet, including thousands and even tens of thousands of processors.

There is clearly a need in the art for methods and systems making use of all these advances in order to assist and to aid chemists in their basic tasks, primarily synthesis of compounds with desirable properties. Such tools should employ to the greatest advantage enabled by modern computer facilities the advances in chemical knowledge and understanding. Further, these tools will have particular use in designing compounds likely to have biological utility in view of accumulated biological data.

Such methods and systems have not existed in the prior art. All that has been available heretofore have been tools that address, at best, limited chemical problems and that search for compounds of with limited properties. These prior art methods have significant additional deficiencies. Compounds that are identified might be entirely hypothetical and not be synthesizable. Even if identified chemicals are synthesizable, they might not be readily synthesizable from precursor compounds readily available to chemists at reasonable cost and in reasonable time. Finally, and perhaps most important, even if the identified compounds are readily synthesizable, no information is provided by the prior art methods as to how the compounds may be synthesized. Examples of prior art systems with such deficiencies are disclosed in, e.g., U.S. Pat. No. 5,434,796; Weber et al., 1999, in Molecular Diversity in Drug Design (Dean et al. (eds.)), Kluwer Academic Publishers, Dordrecht, The Netherlands; Weber

Citation or identification of any reference in this section or any section of this application shall not be construed that such reference is available as prior art to the present invention.

### 3. SUMMARY OF THE INVENTION

The objects of the present invention are to overcome these deficiencies in the prior art by providing computer-implemented methods and computer systems that search a generally-defined space of chemical compounds in order to discover those compounds or libraries with pre-determined computable properties. One key object is that the chemical search space is preferably defined constructively in terms of reactions leading to member compounds so that compounds and libraries with suitable properties are known to be synthetically accessible using known reactions. Another key object is that the constructive search-space definitions provide for syntheses involving multiple separate reactions that may be grouped in multiple separate synthetic steps. A further key object is that the constructive definitions make use of simulation techniques of sufficient accuracy, and that the procedures for the computable properties return values of sufficient accuracy. What is sufficient accuracy is determined by each particular application of this invention. Yet another key object of this invention is that the methods for searching the constructively-defined chemical search space are amenable to parallelization so that any lengthy calculations for separate compounds being searched, such as for example computation of the desired properties, may be performed in parallel on parallel systems.

A preferred embodiment of the present invention comprises a method for planning the synthesis of one or more chemical compounds with specified chemical properties, comprising the steps of: (a) representing a space of synthesis plans, wherein each synthesis plan in the space of synthesis plans represents one or more virtual reaction schemas applied to one or more classes of virtual input reactants; (b) representing a space of virtual compounds, wherein each compound in the space of virtual compounds is a product of one or more of said synthesis plans; (c) constructing a first mapping from the space of virtual compounds to a range space, wherein the first mapping is determined by one or more compound properties being measured; and (d) searching the space of synthesis plans. Preferably the step of searching comprises at least the following steps: (i) for a selected synthesis plan, simulating the synthesis represented by the plan to obtain one or more virtual compounds in the space of virtual compounds, (ii) mapping the synthesis plan to the range space by applying a second mapping, wherein the second mapping is constructed by (a) mapping the synthesis plan to its products in the space of virtual compounds, then (b) mapping the products of the synthesis plan to the range space using the first mapping, and (iii) repeating steps (i) and (ii) until the second mapping applied to least one selected synthesis plan maps to a pre-determined subset of the range space.

In a further preferred embodiment, the invention comprises a method of identifying chemical compounds with specified properties, comprising the steps of: (a) defining a first generation of one or more chromosomes comprising one or more educts and one or more reactions; (b) for each chromosome, sequentially performing virtual reactions cyclically, first on the educts, then on resulting reaction products, until a predetermined event occurs; (c) assigning one or more fitness function values to reaction products resulting from step (b); and (d) assigning one or more fitness function values to each of the chromosomes, based on fitness function values assigned to reaction products in step (c). Preferably, the method also comprises performing steps (b) through (d) on one or more subsequent generations of chromosomes, where each generation is derived from the preceding generation using genetic operations.

### 4. BRIEF DESCRIPTION OF THE FIGURES

The present invention may be understood more fully by reference to the following detailed description of the preferred embodiment of the present invention, illustrative examples of specific embodiments of the invention and the appended figures in which:

FIGS. 1A-B illustrate a preferred method for simulating single and multiple synthetic steps;

FIGS. 2A-B illustrate typical application of the present invention;

FIG. 3 depicts evolutionary steps of a preferred method;

FIG. 4 depicts preferred genetic operations (mutations and crossovers) that derive a generation X+1 from a generation X;

FIG. 5 depicts data structures used in a preferred embodiment of the present invention;

FIG. 6 depicts a lidocaine molecule;

FIG. 7 depicts a method of lidocaine synthesis;

### 5. DETAILED DESCRIPTION OF THE PREFERRED EMBODIMENTS

Preferred embodiments of this invention include, inter alia, multi-dimensional chemical search spaces in which large numbers of chemical compounds are represented along with their methods of synthesis, and also methods for searching these chemical search spaces for compounds or syntheses having pre-specified properties. A key aspect is that the search spaces is that they contain compounds that are synthetically accessible by a chemical reaction, a multi-step synthesis or by multiple sequential reactions. Preferred embodiments also include software for performing the methods for defining and for searching the chemical search spaces as well as systems for executing this software.

Also preferred are more specific embodiments in which these search spaces are synthetically accessible by using specific and desirable types of reactions, chosen for, inter alia, their reliable simulation and predictable outcome, and further in which specific types of representations, chosen for, inter alia, their balance of computation efficiency and chemical fidelity.

These preferred embodiments have wide applicability to the discovery of new compounds of diverse structures and having the properties of many sorts while being synthesized according to a selection of known synthetic methods. These embodiments may also be applied to discovering new ways of synthesis to existing compounds of interest.

### 5.1 General Embodiments

A chemist, or other user, seeking compounds meeting certain requirements would turn to this invention to provide at least suggestions of suitable compounds along with their way of syntheses, and preferably to provide full examples of suitable compounds. For example a chemist may apply the present invention in order to assist, or even to solve, such chemical problems as finding small-molecule ligands along with their syntheses that are likely to bind to a particular receptor, or finding syntheses of a particular compound, or of compounds similar in some manner to the particular compound, that employ only reagents currently on hand in reactions within current capabilities, or so forth.

Accordingly, to use the present invention, a user will specify compound requirements in a computable form, such as a program that can be executed on a computer to return a measure of the suitability of a proposed compound. Additionally, the user will specify his “chemical search space,” which is a virtual collection of chemical compounds specified according to the methods of this invention, and which is searched by further methods of this invention to find suitable compounds

This subsection describes in detail general embodiments of chemical search spaces according to this invention, illustrates a range of exemplary, computable requirements, and then describes preferred and alternative search methods. A following subsection describes preferred specific embodiments in which the general embodiments are applied to preferred search spaces.

### 5.1.1 Chemical Search Spaces

A chemical search space is at least a collection (or set) of chemical compounds that is “virtual” in the sense that the compounds in question are not necessarily actually synthesized in the laboratory and then tested, but instead are simulated by the methods of this invention. In more specific embodiments, certain of the compounds being searched by this invention may be synthesized and tested, but preferably only the compounds that have already been determined as likely to be suitable for the requirements at hand will be actually realized. The methods of this invention preferably specify, or define, chemical search spaces by means of constructive methods or definitions. Other search space definition methods may also be used, among which is described a less preferred enumeration method.

According to a preferred constructive definition, a chemical search space includes all those compounds that may be synthesized from a defined collection of precursor reagents by application of one or more chemical reactions. In other words, a search space may be considered as all compounds that are “synthetically accessible” from selected precursors by use of chosen chemical reactions. Although this invention is certainly useful for simple search spaces, such as all compounds that can be synthesized from the specified precursors in a single step by a single reaction, it is principally useful for the more complicated search spaces that result from multiple steps of multiple possible reactions applied to precursors. In the following this preferred multi-reaction application is assumed, but without any intended limitation.

In practice, a chemist (or other user) may specify a constructively defined search space for a particular problem simply by selecting the precursor reagents available to the chemist for constructing compounds to solve the problem at hand and also by selecting the reaction types that the chemist is prepared to perform on these precursors. Then, starting from a constructive definition, methods of this invention construct compounds in the search space by simulating operation of the reactions of the selected types applied to the chosen precursor compounds, and then to their products, and so forth. Accordingly, any compound constructed in the search space is automatically accompanied by a synthesis plan. All that is necessary is for the methods to keep track of the simulated synthetic steps, which led to any particular compound from the precursor reagents.

For example, a user/chemist seeking receptor-binding ligands may select as precursors those reagents currently available to the chemist in the laboratory or warehouse, while selected reaction types may include those with which the chemist is currently familiar along with others with which the chemist has little previous experience. This invention will then search for likely ligands among the compounds synthetically accessible from these selections. In this manner, the present invention can help the user/chemist break out of accustomed practices and through patterns by suggesting new compounds resulting from synthesis plans new to the user/chemist. In fact, many of the simulated compounds are likely, not only to never have been conceived by the user/chemist, but in fact to be entirely novel compounds.

Less preferably, a search space of compounds may be realized by a process of simple enumeration. Here, compounds may be described by schemas having fixed sub-structures linked with variable sub-structures, where the variable substructures are chosen from selected classes or groups. Compounds may then by constructed by selecting, perhaps sequentially, variable sub-structures and combining them with the fixed sub-structures according to the schema. Simple enumeration is similar, for example, to a Markush description of a generic class of compounds. In more complex embodiments, enumeration may be recursive, where, for example, the variable sub-structures of a first schema are specified in turn by further schema specifying their construction from further variable or fixed schema. However, because compound schema do not generally incorporate any synthetic knowledge, there is no guarantee that a generated compound may in fact be synthesized, and even if it may be, the process of enumeration provides no synthesis plan.

In summary, constructive search-space definitions are preferable for at least the following reasons. First, compounds in a constructively defined search space are necessarily synthetically accessible, because the only way a compound can be in the search is for it to have been reached by a simulated synthesis. Second, constructive definition is likely to lead to search spaces of compounds that the user/chemist did not initially conceive, and may in fact include entirely novel compounds. Finally, constructive definition is more compact than an exhaustive enumeration.

### Reaction Representation

Turning now in more detail to the preferred constructive search-space definitions, these definitions preferably include two levels of simulation: a first level represents individual chemical reactions of pre-determined types; and a second level treats the results of placing precursors (also known equivalently as “reactants” or “educts”) in a single reaction vessel (a single “pot” reaction) where they may undergo more than one type of reaction. In alternative embodiments, search-space definitions may include only the first level of simulation where this is adequate to the chemical problem at hand. Further, search-space definitions may include a third-level of simulation that addresses the outcome of reactions that may occur sequentially in several vessels (a “multi-pot” reaction), perhaps with intermediate purification of the results of one vessel's reactions before commencing the next vessel's reactions. Individual reaction representation is described next with the further definitional levels described subsequently.

In the present invention, reactions may be represented in a hierarchy of increasing levels of complexity, which preferably represents increasing levels of chemical and physical accuracy. A very lowest hierarchical level of reaction representation is described first with respect to the following elementary but adequate example.
Reactants: R₁—X where R₁ is an unbranched hydrocarbon and X is a halogen, and R₂—OH where R₂ is an unbranched hydrocarbon.

Reaction: R₁X+R₂OH→R₁—O—R₂.

The reactions represented by this elementary reaction type are simply nucleophilic substitutions of hydrocarbon halides (R₁X) by hydrocarbon alcohols (R₂OH). In this representation, which is an example of what is called herein a “syntactic representation,” reactants, upon which the reaction at hand operates, and products, output from the reaction at hand, are represented as symbol strings having constant symbols (here, “X” and “OH”) indicating relatively fixed substructures, variable symbols (here, “R₁” and “R₂”) indicating variable substructures, and structure symbols (here, “—”) indicating the substructures chemical linkage of the fixed and variable substructures according to one of the standard chemical notations. Generally, constant symbols in reactant representations, consistent with typical usage for chemical reaction representation, usually stand a particular functional group (for example, “OH”) or for a class of closely-related functional groups (for example, “X”) present in the reactant (or product) molecules involved in the reaction at hand. The variable symbols generally stand for portions of the reactant (or product) molecules not considered to be affected by the reaction, and therefore may represent chemical substructures without particular limitations. Then, the reaction at hand, generally a reaction of a certain type, is represented by a transformation of reactant symbol strings into one or more product symbol strings. The constants symbols in the reactant strings are usually transformed into constant symbols in the product(s) according to the type of the reaction at hand. The variable symbols in the reactants are usually represented by variable symbols in the product(s). Reaction representations may also specify production of alternative main products (with a particular branching ration), or production of side products, or so forth.

Representation of strings with fixed and variable symbols, representation of their transformations, and various implementation algorithms have long been well known to those of ordinary skill in the computer sciences. Any of the several methodologies that have been developed for such problems may be used for this syntactic reaction representation. A preferred, known syntactic representation, known as the SMILES, SMARTS, and SMIRKS languages is provided by Daylight Chemical Information Systems, Inc. (Mission Viejo, Calif.; www.daylight.com). See, e.g., Weininger, 1988, J. Chem. Info. Sci., 28, 31; James et al., Daylight Theory Manual—Daylight 4.71, Daylight Chemical Information Systems, Inc., Mission Viejo, Calif. (2000). Other similar representations are equally applicable in the present invention.

Transformation of specific reactants into specific products according to a syntactically-represented reaction requires that the variable symbols in the reactants be instantiated to represent specific chemical substructures. Then, reactants with these specific substructures lead to products with these same substructures according to the represented reaction. Instantiation of variable symbols may be carried out in various ways depending on the various applications of the present invention. For example, if a reaction is the first reaction specified in a constructive search-space definition, then the reactants are preferably the “precursor” reagents selected by the chemist/user to define the search space in the first place. Depending on the number of selected precursors, it may be simplest to provide lists of possibilities for the various variable symbols. With reference to the example above, “R₁” and “R₂” may simply be selected from a list of linear, unsaturated hydrocarbon moieties. Alternatively, precursors may be all suitable compounds available in the laboratory or in a warehouse, which will advantageously be stored in an inventory database of some sort. In this case, the compound schema may be used a search query to retrieve all available compounds that can satisfy the schema. Such a retrieval may be automated by, for example, sequentially seeking database compounds that match the string pattern in the search query by using any one of a number of known string matching algorithms. Further, a chemist/user may look more broadly for precursors for a particular problem, in which case databases of commercially available compounds, or even databases of known compounds may be searched.

If a reaction is used along with other reactions in a particular constructive search-space definition, its input reactants may not be limited to precursors selected by the chemist/user, but instead may include products of other reactions. The precursors may have been transformed by one or more previous reactions before the search-space definition calls for the reaction at hand. In this case, as will be described in more detail subsequently, there will be a set or collection of currently-available virtual compounds which may be searched using the reactant symbol strings as queries for possible matches, much as the previously-described database searches. In this manner, a represented reaction may be virtually performed both, as an initial or as a subsequent reaction in particular constructive definition.

Before proceeding to more complex reaction representations, the less preferred enumeration of search spaces is briefly described. The above example is sufficiently elementary that the generated search space may be completely described by the single schema.
Schema: R₁OR₂, where
   R₁ and R₂ are unbranched hydrocarbons.
      Hence, the search space may be simply enumerated by constructing all unbranched hydrocarbons, a very simple graph manipulation exercise. More generally, the variable symbols in an enumeration schema may be constructed as, for example, as chemically-correct graphs in the selected classes. Chemically correct graphs are usually to more than the well-known graphical representations of molecules according to a valence model.

At a next level of complexity, the basic syntactic reaction representation may be supplemented by more comprehensive chemical knowledge concerning reactions. One class of additional chemical knowledge concerns the effects that invariant substructures, represented syntactically by variable symbols, can have significant effects on reaction products. These effects may be simply, but again adequately, represented with reference again to the example above, which defines a chemical search space of unbranched hydrocarbon ethers. Without further structural limitation, R₁ may have the following structure.
R₁ ≡R₁′—CH═CH

In this case, the products of the substitution reaction are likely to be the following:
R₁X+R₂OH→R₁′—CH═CH—CH₂OR₂+R₁′—CH₂(OR₁)—CH═CH₂.
In other words, the products are not limited to the unbranched hydrocarbon ethers sought, but may also include branched hydrocarbon ethers as well. This problem may be avoided if R₁ is limited to unbranched hydrocarbons without, at least, terminal unsaturation. Generally, therefore, it may be advantageous, depending on the reaction types of interest in an application of the present invention, to include knowledge concerning effects of adjacent unsaturation, aromaticity, heteroatoms, electron donating or withdrawing groups, stearic strain or hindrance, and so forth, either by requiring the absence or the presence of such structures in the otherwise invariant substructures of reactants.

This knowledge may be represented preferably by conditions on variable substructures of reactants, which must be met if the reactants are to be suitable for a particular reaction. Conditions of this sort may be concretely implemented in numerous fashions. In one preferred embodiment, condition may be specified by structure rules supplementing and associated with reaction descriptions that are used to assess the suitability of candidate reactants. In one format, the rules may have predicates (“if” clauses) testing for the presence or absence of a particular effects in a candidate reactants' variable substructure, and may have consequents (“then” clauses) specifying particular actions if the “if” clause is satisfied. Predicates may, for example, test for groups in variable substructures, such as the absence of terminal unsaturation or the presence of an otho-para electron donating group, by attempting to match a patterns with fixed and variable symbols to a candidate substructure. This match may be implemented as described above for reaction representations in general.

The actions specified by “then” typically alter the search of the chemical compound search space. In an unsuitable group is found on a candidate substructure, then reactants containing this substructure may be passed over in the search. Further, reactants containing substructures derivable from all unsuitable structure may also be passed over (i.e., the tree of compounds rooted at the unsuitable substructure is pruned from the search space). Alternatively, reactants with unsuitable substructure may simply be assigned a lowered search priority, so that they, along with trees branching from the unsuitable reactants, are simply searched later than more suitable reactants. On the other hand, search priorities may be increased if a substructure is particularly favorable for the reaction at hand. Consequents may also specify or invoke reaction alternatives. Since nearby groups may open additional reaction pathways or stabilize intermediates, “then” clauses may change branching ratios between two or more possible reaction outcomes, or even change a hitherto rare outcome into a measurable outcome. Rules may also test for other influences on an intended reaction. For example, rules may be sensitive to the characteristics of solvents used or the presence of catalysts. “If” clauses may test for the polar or a polar, it the protic or aprotic nature of a solvent, or for the presence of absence of acid or base catalysts. Dependent “then” clauses may specify different branching ratios, or even different outcomes, that result from the changed mechanisms made possible by such reaction conditions.

Thus much chemical knowledge modifying or modulating reactions may be added to the basic syntactic representation by means of rules. Further, chemical knowledge representation as rules, and in other embodiments, chemical knowledge may be represented by other knowledge representations known in the arts of artificial intelligence while still remaining within an essentially syntactic representation. See, e.g., Giarratano et al., Expert Systems—Principles and Programming, PWS Publishing Co., Boston Mass. (1998).

Finally, at greater levels of representational complexity and chemical accuracy, constructive search-space definitions may involve direct and computable representations of physical and chemical knowledge, instead of indirect representations using pattern matching of syntactic and textual elements. Simple direct representations may include linear free-energy models of the transition state from which relative reactivities and branching ratios may be predicted. Direct representations may also include, for example, calculation of activation state free energies and total reaction free energy changes for one or more possible reaction pathways. These energies may also be used predict branching ratios of possible outcomes where reactions are kinetically controlled or are equilibrium reactions. Many tools are known and available for such calculations, ranging from special tools for small molecules, to molecular mechanics models, to quantum chemistry calculations, and so forth. See, e.g., Hehre et al., A Brief Guide to Molecular Mechanics and Quantum Chemical Calculations, Wavefunction, Inc., Irvine, Calif. (1998); and modeling tools from, e.g., Wavefunction, Inc. (Irvine, Calif.; www.wavefun.com, accessed Oct. 1, 2001), Schrödinger, Inc. (Portland, Oreg.; www.schrodinger.com, accessed Oct. 1, 2001).

More generally, a chemical-reaction database should comprise as many known chemical reactions, reaction products and reaction conditions as possible, having a diverse database should increase the likelihood of finding a chemical compound that most closely satisfies fitness-function criteria Here, ‘known’ means known publicly, e.g., via scientific-journal, patent-office or Internet publication, or known by a particular chemist/user only.

Data for each chemical reaction should include the chemical structures and names (IUPAC names, trivial names, or Chemical Abstracts registry numbers) for all reactants; reaction conditions, including solvent, reaction-time and reaction-temperature information; and identifiable reaction products, including stereoisomers and enantiomers if relevant, and their respective yield and chemical or physical properties. The reaction products' chemical or physical properties, which can be used to determine a reaction product's fitness to one or more fitness-function criteria, are defined by the above fitness functions.

Where a chemical reaction produces more than one product, which is usually the case, information relating to each products' yield is especially important, with reactions that produce their desired product in relatively high yield preferred. If the chemical-reaction database includes more than one chemical reaction that produces the same product, but in a different yield, the methods of this invention can actively, and advantageously, discriminate against low-yield reactions. This being said, however, low yield is better than no yield. A chemical reaction that produces a product in very low yield might be the only known method for obtaining that product, which might turn out to closely fit a desired fitness-function criterion. It might also be useful for the chemical-compound database to include a list of attempted reactions that failed to provide products.

The chemical-reaction products' chemical or physical properties can be used to determine a reaction product's fitness to one or more fitness-function criteria. Accordingly, the chemical-reaction database should comprise as much chemical- or physical-property data for the reaction products as possible. These data can be experimentally determined or obtained from publicly available sources, such as Beilstein, The Handbook of Chemistry and Physics, The Merck Index and other compilations, including those comprising spectral data. But it is time-consuming to input these data into the chemical-reaction database. Having a computer program estimate a reaction product's chemical and physical properties, however, is relatively expeditious. Preferably, the computer program can estimate, potentially via molecular modeling, one or more of these properties from a reaction product's two-dimensional structure or other syntactic representations.

### Single and Multi-Vessel Reaction Representations

Constructive definitions of chemical search spaces may also have second and third levels which represent the net outcomes of synthetic steps occurring in single and multiple reactions vessels where more than one reaction is possible among the available precursor or intermediate compounds. These higher levels make use of single reaction representations, as just discussed, supplemented with additional operations modeling reaction vessels and transfers between multiple reaction vessels.

In the following description, representations of reactants and reactions, the methods of selection of reactants, for example, from databases, and methods of simulating reactions, are according to the description just above. Further, according to this invention the term “reaction vessel” is not to be limited to “vessels” of any particular size or capacity. Thus methods and systems of this invention may be applied to syntheses involving larger (“macroscopic”) amounts of reagents and products and macroscopic vessels, that is volumes on the order of milliliters and amounts on the order of milligrams. They may also be applied to smaller syntheses involving smaller (“microscopic”) amounts, such as nanoliter and nanogram amounts and microfluidic type reaction devices. Additionally, control of reaction conditions and transfer between synthetic steps may be by manual means, or by automated, robotic means, or so forth.

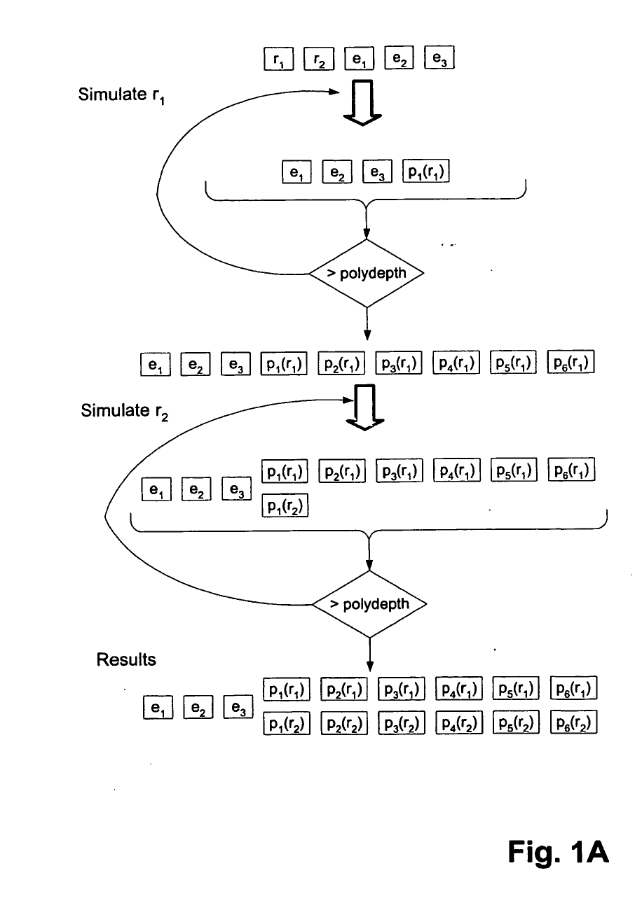

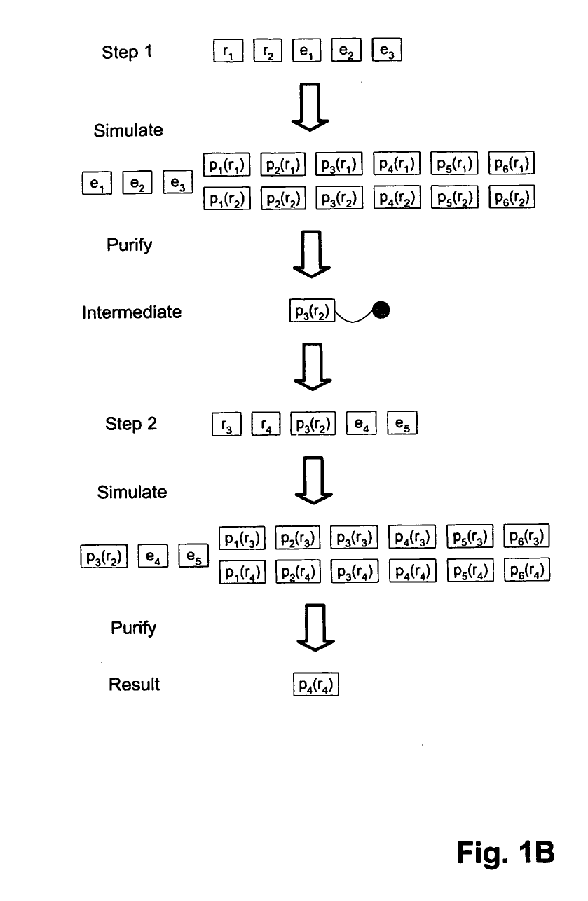

One preferred method for simulating and representing the outcome of single reaction vessel (single “pot” or single step) syntheses is now described with reference to FIG. 1A, which is an example of this simulation method. Here, an initial state in the reaction vessel is illustrated at 1, where, for example, three reactants, denoted by e₁, e₂, and e₃, are present in the vessel which are capable of reacting according to, for example, two reactions, denoted by r₁ and r₂. If this is an initial step in a search space definition, then the reactants will be selected precursor compounds from which the space is ultimately constructed. If this is a later step, then the reactants will typically be the products of earlier steps. The outcome of this step is simulated by applying first reaction r₁ and then reaction r₂, where preferably it is the case that none of e₁, e₂, and e₃ are capable of initially reacting according to r₂.

Thus, the available reactants react first according to reaction r₁, and in a first round (that is, a single application of the reaction), this reactions produces the product illustrated at 2 and denoted as p₁(r₁), where generally “p_{L}(r_{M})” represents the L'th product of a round of the M'th reaction in the current conditions in the current reaction vessel. If no further reaction according to r₁ is possible, then the simulation immediately proceeds to the next reaction r₂.

However, depending on the reaction and the initial reactants, it may be possible for certain of the first round products to satisfy the conditions for further reaction according to reaction r₁ resulting in additional second-round products of the first reaction. In certain cases, e.g., if the first reaction is a polymerization process, it may be possible for products to repeatedly react for a large number of rounds. As FIG. 1A illustrates, the preferred method simulates reaction r₁ for a number of rounds of repetition no greater that an allowed number of iterations, after which the simulation proceeds to the second reaction. The simulation also proceeds to the second reaction if no further reaction is possible even if less than the number of iterations have been simulated. This may occur if, for example, all possible reactants have already been substantially exhausted and the resulting products are not capable of reacting according to r₁.

If such reaction repetition is the result contemplated and sought by the chemist/user for the construction of a particular search space, then the number of iterations may be set to a large number. More commonly, however, a chemist/user seeks more controlled and defined outcomes leading to a search space of compounds of more limited molecular weights. In this case, the number of iterations is set to a smaller number, for example, from 5 to 10, and conditions in the reaction vessel are adjusted accordingly (for example, by limiting initial concentrations of a key reactant, or by limiting reaction time, or so forth). FIG. 1A illustrates at 3 that repetition of reaction r₁ for a number of rounds results in further products P₂(r₁), p₃(r₁), p₄(r₁), p₅(r₁), and p₆(r₁) in addition to the product p₁(r₁) of the first round of reaction r₁.

Next, reaction r₂ is simulated using as reactants the reaction vessel contents constructed according to the simulation of reaction r₁. These contents include at least the simulated products of r₁, namely p₁(r₁) to p₆(r₁). Further, depending on whether or not reaction r₁ is of a type that establishes an equilibrium or runs to completion, there may or may not be quantities of the initial reactants, e₁, e₂, and e₃, remaining in the vessel. Step 3 illustrates the case where quantities of the initial reactants are remaining. As above, one round of reaction r₂ results the product p₁(r ₂) at step 4, and repetition of r₂ for a number of rounds results in further products p₂(r₂), p₃(r₂), p₄(r₂), p₅(r₂), and p₆(r₂) at step 5. The number of iterations for r₂ may be different from the number chosen for r₁, depending again on the intrinsic characteristic of the reaction and the conditions established in the reaction vessel. Optionally, The number of iterations may be established for each reaction separately and stored as part of the reaction representation. If reaction r₂ runs to completion, all products of reaction r₁ may be consumed.

Since the chemist/user specified no further reaction were possible in this first step taking place in the first reaction vessel, simulation of the first step taking completes, if neither r₂ nor r₂ run to completion with the first reaction vessel including products of reaction r₁, namely p₁(r) to p₆(r₁), products of subsequent reaction r₂, namely p₁(r₂) to p₆(r₂), along with quantities of the initial reactants, namely e₁ to e₃. If reaction r₁ runs to completion, then the initial reactants may be substantially absent at step 5, and if reaction r₂ runs to completion, then the products of reaction r₁ may also be substantially absent at step 5. (If both reactions run to completion, then only products of reaction r₂ will be substantially present at step 5.) Further, it is to be understood that the specifics illustrated in FIG. 1A and just described are merely exemplary. For example, the first step may include only one reaction or three or more reactions; there may be less than three or more than three initial reactants; the reactions may products any number of products which may differ from reaction to reaction, and so forth.

The present invention also includes optional additional levels of constructive definition of chemical search spaces. One further level includes the results of two or more synthetic steps performed sequentially, typically in separate reaction vessels, and is described with reference to FIG. 1B illustrating an exemplary two step synthesis. As with FIG. 1A, the numbers of steps, precursors, products, and so forth are mere exemplary, the present invention applying to simpler or more complex multistep syntheses. Further, not all precursors or reactants may appear among the final products at any step.

Step 1 in FIG. 1B illustrates simulation of the first synthetic step, in which three precursors, e₁, e₂, and e₃, are capable of reacting according to two reactions, denoted by r₁ and r₂. As in FIG. 1A, the contents of the vessel upon completion of step 1 include products of reaction r₁, p₁(r₁) to p₆(r₁), products of reaction r₂, p₁(r₂) to p₆(r₂), possibly along with quantities of the precursors, e₁ to e₃. Characteristic of multistep, multivessel reactions is that not all products remaining from a first step are used as initial reactants for a second, or subsequent, step. In order words, one or more products, which, for example, may interfere with subsequent steps of the search-space definition, are separated from the step 1 results before beginning step 2. Stated differently, the step 1 results are next purified. Purification may be represented generally by a transformation of the products of a prior step that increases the relative abundance of a desired product (or products) while reducing the abundance of undesired products. Purification, which ideally substantially eliminates by-products, may be accomplished as known in the chemical arts, for example, by crystallization, by chromatography, by electrophoresis, by solid-state attachment, or so forth.

Accordingly, FIG. 1B at step 6 illustrates an ideal purification which discards all but the third product of the second reaction, product 7 or p₃(r₂). The method of purification here involves arranging step 1 so that product 7 is obtained attached to solid state support 8 from which other products are washed. Next, the second synthetic is simulated, in which two additional reactants, e₄ and e₅, along with product 7, or p₃(r₂), react according to two additional reactions, r₃ and r₄. Again, the contents of the second vessel upon completion of step 1 include products of reaction r₃, p₁(r₃) to p₆(r₃), products of reaction r₄, p₁(r₄) to p₆(r₄), possibly along with quantities of the reactants, e₃, e₄, and p₃(r₂). Finally, for exemplary purposes, since product 10, the fourth product of the fourth reaction, p₄(r₄), is found to satisfy the problem being addressed, it is purified from the other products in step 9 of FIG. 1B. More complex multistep, multivessel reactions may be simulated in a manner analogous to this exemplary two step syntheses.

In alternative embodiments multistep syntheses may not require an equal number of “vessels” and transfer between vessels. For example, if desired products are synthesized attached (directly or indirectly) to solid state supports, intermediate separations may occur without transfer from vessel to vessel. Also, if the unwanted products of a prior step do not interfere with its subsequent step, then separation may be avoided. In FIG. 1B, this would allow purification step 6 to be omitted. Other alternatives that are known to those of skill in the art for multistep reactions are also included within this invention.

### 5.1.2 Search Objectives

As compounds in a chemical search space are generated according to its selected constructive definition, they are evaluated for suitability according to selected objectives. Although objectives are most preferably expressed in a form computable from compound representations, in some embodiments it may be advantageous from time to time to physically synthesize a constructed compounds and to physically evaluate its suitability. In this manner, the search for suitable compounds usually conducted by computation of suitability may be more carefully guided by more accurate physical measurement.

In preferred embodiments, therefore, a chemist/user will select search objectives that are computable from compound structure by a computer program. A wide range of computable objective may be employed in the present invention, although it is preferably that the objectives represent a more or less accurate simulation of some physical fact or occurrence so that the search results are more meaningful. A large number of such physically-derived simulations are known in the art and are available for use in this invention, singly or in combination. In this subsection, certain exemplary objectives are described with reference to typical applications.

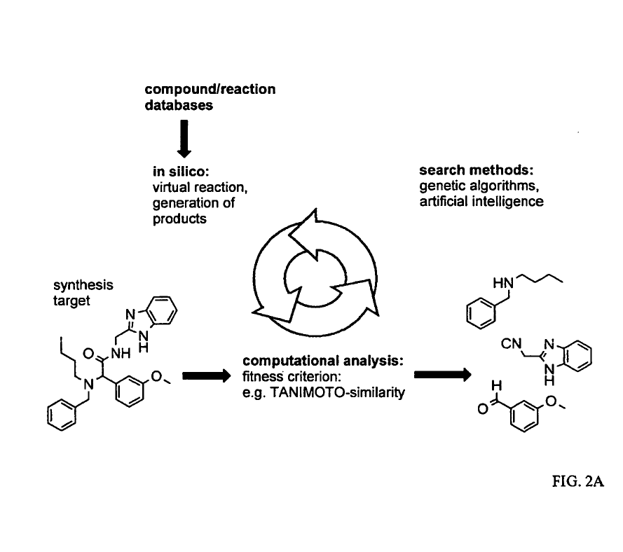

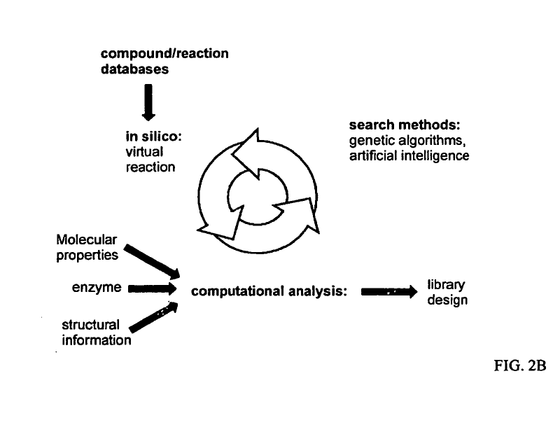

Two general types of application are illustrated in FIGS. 2A-B. In both figures, the compound/reaction databases designate the databases from which constructive search-space definitions, also known herein as “virtual reactions,” and precursor compounds are selected by the chemist/user as described above. Computational analysis designates application of computable objective functions, also known herein as “fitness functions,” to compounds in the search space generated by the virtual reactions. The nature of the computational analysis varies from application to application. Search methods, described subsequently, designate the processes controlling the generation of new search space compounds and their evaluation by computational analysis. The iterative and repetitive nature of the search methods is represented by the circular arrangement of arrows.

Specifically, FIG. 2A illustrates a first general type of application according to which one or more target compounds (illustrated as synthesis targets) are known, and the present invention is employed to explore alternative syntheses using the reaction types selected to generate the search space. FIG. 2B illustrates a second general type of application according to which, although target compounds are not known, properties of a suitable target are known, and the present invention is employed to suggest possible target compounds. As illustrated, target properties may include molecular physical or chemical properties, or properties relating to interaction with known enzymes (or receptors, or other biological targets), or molecular structural properties.

### Search for known Compounds

Turning in more detail to applications of the first general type, a basic objective function simply determines whether a generated compound has the same structure as a target compound (perhaps, one of several target compounds). In one implementation, this calculation may be done by representing the generally three dimensional (3D) graphs of both the constructed and the target compounds and then testing the graphs for identity. Since testing for graph identity can become a computationally expensive problem for large compounds, preferred implementations construct fingerprints of the compounds to be tested, which are then checked for identity. Only compounds with identical fingerprints are actually tested for true identity. A compound fingerprint may simply be all connected sub-graphs of the compound up to some finite pre-determined order; other compound fingerprints well known in the chemical arts. See, e.g., Tanimoto similarity [Tanimoto, T. T. (1957) IBM Internal Report 17th Nov see also Jaccard, P. (1901) Bulletin del la Société Vaudoisedes Sciences Naturelles 37, 241-272] Further, packages for determining and testing compound fingerprints are commercially available. See, e.g., The Fingerprint Toolkit from Daylight Chemical Information Systems, Inc.

Along with fingerprint identity (or compound identity), other objective or fitness functions may be advantageously employed in this application. For example, the number of synthesis steps (or required “vessels”) or the total synthesis yield may be used as fitness functions to select preferable from less preferable syntheses. The yield of a multistep reaction may be routinely determined from the yields of the component individual reactions, which may be stored as part of the reaction description. Other reaction characteristics may be quantitatively or qualitatively coded and used as objective functions. For example, the cost of precursor reactants, or the cost of performing the reaction, or the reliability of the reaction, or so forth, may be stored in reaction and compound databases and used to select further preferably reactions.

### Search for Unknown Compounds

A principal general application of the present invention to find compounds satisfying particular chemical or physical properties computationally accessible from two-dimensional (2D) or three-dimensional (3D) structures. Here, exemplary objective (or fitness) functions are discussed that are illustrative of the breadth of possible applications. In many cases, if compounds with a particular property value are sought, an appropriate function would depend on the difference of the value sought and the value computed for a candidate compound.

Chemical or physical properties may be used as objective functions. These properties include, for example, number and type of nucleophilic or electrophilic moieties; number and type, (e.g., sp, sp² or sp³) of covalent bonds; number of substantially ionic bonds; strengths of certain interatomic bonds; refractive index; pH and pK values; spectroscopic information such as portions of NMR, IR, and UV spectra; as well as other computable chemical or physical properties.

One structural property important in drug discovery is molecular flexibility, conveniently represented by the number of bonds about with free rotation may occur (e.g., the number of sterically unhindered sp³ bonds). Flexibility is not advantageous because it may weaken energetically-strong binding of a drug to a target by causing a significant decrease in entropy on binding, the flexible solution-phase molecule having many alternative conformations while the bound molecule having only one (or at most a few) conformations.

More elaborate chemical and physical properties also may be calculated by physics-based computational programs employing, for example, Monte Carlo methods, molecular dynamics, semi-empirical quantum mechanics methods, ab initio quantum mechanics methods, or so forth. See, e.g., Hehre et al., A Brief Guide to Molecular Mechanics and Quantum Chemical Calculations. Quantum-mechanics-based programs can also provide molecular surface characteristics at, for example, the highest occupied orbital or the lowest unoccupied orbital, and can evaluate surface distributions of charge, of nucleophilicity or electrophilicity, or electrostatic potential, and so forth. Such surface distributions can then be used in further fitness functions evaluating the likelihood of a compound binding to or reacting with a target.

A useful class of fitness functions originates from empirically-derived models which correlate certain molecular structures (or other properties) of known compounds with a particular property measured for the compounds. Correlation may employ regression methods, neural networks, or other tools of statistical pattern recognition. QSAR models are examples of this class fitness functions. See, e.g., Grund, 1996, in Guidebook on Molecular Modeling in Drug Design (Cohen, ed.), pg. 55, Academic Press, San Diego, Calif.; Fujita, 1990, in Comprehensive Medicinal Chemistry (Hansch, et al., eds.), pg. 497, Pergamon, Oxford. One QSAR-like model of particular interest in drug design is the CLOGP program, which calculates an octanol-water partition coefficient as a measure of hydrophobicity or lipid solubility. See, e.g., Leo. et al., 1990, in Comprehensive Medicinal Chemistry, pg. 497. Fitness functions derived from QSAR-like models may also be used to evaluate aspects of biologic reactivity. For example, reactivity of a number of active compounds with respect to a particular biologic function or, more specifically, at a particular receptor for a number of compounds may be modeled on the basis of particular structural or physical aspects of the active compounds, and the model then used to predict the activity of other compounds. The CoFMA program is an example of such a model of particular interest that also makes use of 3D conformations of compounds and targets. See, e.g., Cramer et al., 1988, J. Amer. Chem. Soc. 110:5959. Other QSAR-like methods may also be used in the present invention. See, e.g., Kier et al., 1999, Molecular Structure Description, Academic Press, San Diego, Calif.

Where the measured property is the binding to a specified target, methods known in the arts of pharmaceutical chemistry, upon comparison of the known compounds, may be able to derive a “pharmacophore,” which is defined as the minimum set of structural elements necessary for a compound specifically bind to the specified target. For example, a pharmacophore may be defined by the presence and relative spatial arrangement of hydrogen bond donors and acceptors, of regions of electrostatic potential, or particular functional groups, and the like. Then a pharmacophore-fitness function may be defined that reflects the similarity of a generated compound to the desired pharmacophore, as represented by a number depending on, e.g., the presence of the necessary pharmacophore and on the spatial arrangement relative to the pharmacophore structure.

A class of fitness functions particularly useful for drug design do not require knowledge of other active compounds, but instead employ some knowledge of the structure of the target. Such fitness functions may, for example, be derived from docking programs, which use knowledge of the structure and properties binding region of a receptor to evaluate the binding affinty of target molecules. For example, a docking program uses knowledge of the spatial distributions of hydrophobicity, charge, and hydrogen-bonding potential in a binding region to determine compound molecule affinity from the complementarity of the corresponding spatial distributions of the compound. Examples of docking programs are well known in the art and are commercially available. See, e.g., Bohm et al., 1999, J. of Comp.-Aided Mol. Design 13:51-56; Itai et al., 1996, and Koehler et al., 1996, in Guidebook on Molecular Modeling in Drug Design (Cohen, ed.), pg. 93 and 235.

If an embodiment of this invention uses a syntactic representation of target compounds, determination of 3D compound structure from the syntactic representation may be necessary. If a compound to be docked is known, its structure may be retrieved from known structure databases, such as the Cambridge Structure Database (available in the United States from Daylight Chemical Information Systems, Inc.) If no structure is available for the compound, for example if it is novel, then its structure (especially for small compounds with molecular weights less than about 500 or 1000) may be determined by methods well known in the art which are implemented in various commercially available programs. See, e.g., Sadowski et al., 1990, J. Tetrahedron Comput. Method. 3:537.

### Combinations of Fitness Functions

The present invention also may be applied to search for known or unknown compounds having a combination of fitness. For example, a lead compound for development of a drug active against a specified target would certainly need to be able to bind to the target by, e.g., having a pharmacophore determined to be necessary for this binding or having an overall structure that is complementary to the target binding site. However, to be a useful lead, a binding compound should also be “drug-like,” by, e.g., having an appropriate molecular weight, an appropriate hydrophobicity (determined perhaps by the CLOGP program), an limited number of rotatable bonds (determined perhaps by the number of sp³ bonds), absence of excessively reactive groups (such a an acyl halide) and the like. Accordingly, at least these fitness are advantageously combined to guide the compound search. In other applications, other combinations of fitness would be appropriate.

These fitness may be combined in several manners. Preferably, they a combined linearly with fixed importance-based weights. Alternatively, the weights may change as functions of the current fitness. In the above example, it may be advantageous for binding affinity (however determined) to be the sole search criterion until a sufficient affinity is reached, but for compounds with a sufficient or greater affinity, then a combination of binding affinity and drug-likeness may be more advantageous.

Thus most preferably, the methods and systems of this invention provide parameterized (or programming) facilities for combining a plurality of fitness in various user-determined manners.

### Library Searches

Although the present invention is described herein primarily as systems and methods for searching for particular compounds with pre-determined properties, other outcomes are equally possible. In particular, a possible search outcome is a library of compounds having members likely to have the pre-determined properties according to the available fitness functions. Library searches may be particularly advantageous or preferable in cases where available fitness functions are less chemically or physically accurate, because any inaccuracies in the fitness functions may be compensated by screening the resulting libraries by actual experimental methods in order to identify conclusively sought-after compounds.

In one embodiment, libraries may be based on compounds discovered during search. For example, the search may only return compounds with improved, but not necessarily entirely suitable, finesses. On the other hand, discovered compounds may be suitably fit according to the computed fitness functions but experimental confirmation and further improvement is sought. If a large number of such compounds are discovered, they may directly be synthesized and assembled into a library for screening and further testing. If a smaller number of such compounds are discovered, even fewer than 5 or 10, they may individually serve as templates from which libraries may be constructed in various methods by known combinatorial means.

According to certain preferred methods for library construction, a discovered (and reasonably fit) compound may serve as a library template as follows. The discovered compound will necessarily have a constructive synthesis consisting of a known sequence of synthetic steps with known precursor and reactant compounds used at each step. Most simply, a library may be experimentally synthesized by employing the same sequence of synthetic steps but by independently selecting different precursor and reactant compounds for the different steps in place of the known precursor and reactant compounds. This selection may be made from the same collection of compounds using the same methods and same reaction representations as employed in constructing the search space in the first place. Alternatively, the selection may be limited to compounds similar in some sense to the known precursor and reactant compounds. One readily accessible measure of similarity is based on the relative size of the difference in the fingerprints of a known precursor or reactant and a potential replacement precursor or reactant. Where the fingerprint are represented as bit maps, the relative size may merely be the number of on-bits in the exclusive-or of the fingerprints divided by the average of the number on-bits in the two fingerprints. Other similarity measures that are known in the art may be also applied.

Once a library is constructed, either directly from discovered compounds or by using discovered compounds as templates, then its compounds may be screened for fitness. For example, if affinity to a receptor is a component of fitness, then the library may be screening for receptor binding by known experimental techniques. The most fit compounds are then selected, perhaps for further improvement.

### 5.1.3 Search Methods—Evolution Programming

Having described search spaces, and their preferred constructive definition in terms of synthetic accessibility represented by a plurality of simulated reactions, and fitness objectives, and their determination either as single fitness functions or a various combinations of several fitness functions, this section describes the search programming methods (also called search algorithms) that perform the compound search.

As one of skill in the art will now appreciate, a variety of search methods may be employed in this invention. A simplest approach is a random search in which reactants and reactions are randomly varied and the fitness of the resulting products determined. After each determination, a list of one or a few of the most fit compounds found so far may be updated if a more fit compound has been constructed. Another simple approach is a hill-climbing method in which the reactants and reactions are systematically varied so that only compounds of increasing fitness are constructed.

A more preferable search method may be derived from simulated annealing techniques. See, e.g., Press et al., 1992, Numerical Recipes in C, Cambridge University Press, Cambridge, U.K. According to one version of simulated annealing, products from random variations of reactants and reactions are retained if their fitness satisfies a Metropolis condition with a “temperature” that is gradually reduced during the search.

### Evolutionary (Genetic) Search Methods

In preferred embodiments, the search method is programmed according to the paradigm known generally as evolutionary algorithms (EA). EAs have come to represent an important paradigm for solving or approximating the solutions to combinatorial optimization problems, especially hard optimization problems, e.g., the traveling salesman's problem. See, e.g., Zbigniew Michalewicz, Genetic Algorithms & Data Structures=Evolution Programs (Springer 1999). To use the EA paradigm for a particular problem requires that possible solutions to the problem be parameterized by a data structure capable of the “genetic” operations to be described, and that the quality of the solution in the problem be represented by an objective (or “fitness”) function applied to the possible solution. Genetic algorithms (GA) are special cases of EAs where the data structure parameter is a list of indivisible values. In classical GAs, the indivisible values are single bits. The data structure parameter defining a possible solution is known as a “chromosome,” and the individual elements of the data structure are known as “genes.”

Generally, EAs search for increasingly good (or “fit”) solutions, or even an optimal solution, by performing a number of repeated transformations, “genetic” transformations, on a collection of possible solutions represented by “chromosomes.” Each possible solution is known as an “individual”; the collection of possible solutions is known as a “population”; each iteration is known as a “generation.” The process of performing generic transformations in chromosomes is also known as “reproduction.” Generally, the number of individuals in a population is constant from generation and is an important EA parameter.

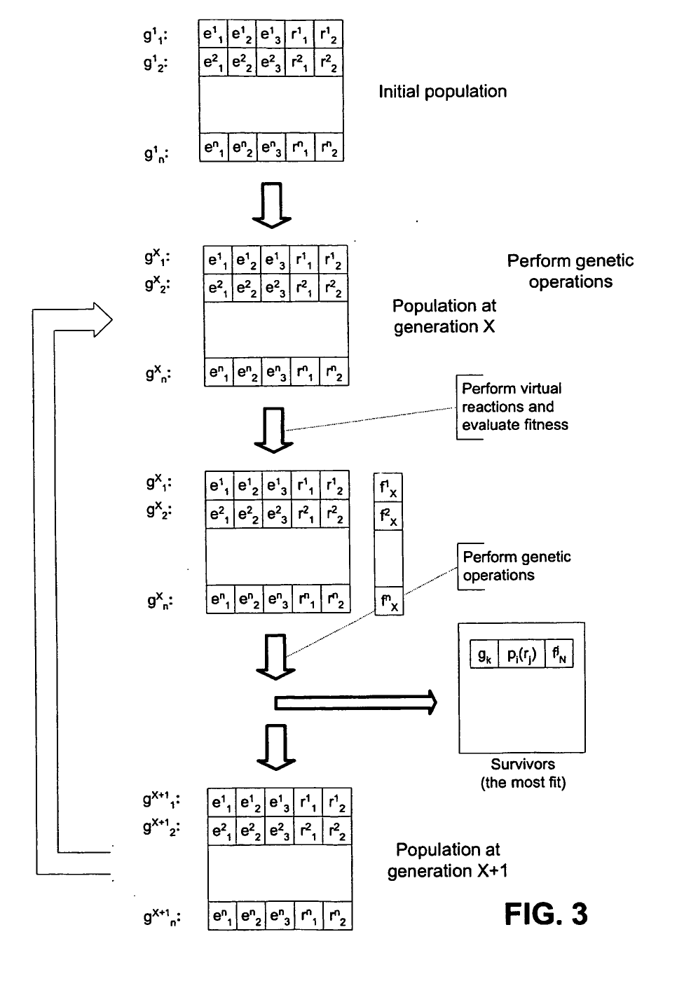

An implementation of GA methods to the chemical search space of the present invention in illustrated in FIG. 3, where the details of particular numbers of reactants, reactions, populations, generations, and the like is merely exemplary. In FIG. 3, the i'th individual at generation (or iteration) X is represented by a chromosome designated by c^{x}ᵢ. The chromosome is exemplified as a list of three reactants (or educts), eⁱ₁, eⁱ₂, and eⁱ₃, and two reactions, rⁱ₁ and rⁱ₂; and represents product compounds according to a simulation illustrated in FIGS. 1A and 1B. The entire population, of size N, at a generation X is represented by a list of chromosomes, c^{x}₁, c^{x}₂, . . . c^{x}_{N}. For example, population 301 is an initially selected population; population 302 is the population at generation X (with certain individuals marked for reproduction); and population 311 is the population at the next generation, X+1. Populations 305 and 307 are in the process of reproduction and selection and may transiently have M individuals, which is typically more then N.

Generally, each generation of the iteration, as illustrated in FIG. 3, includes four basic steps. In a first step for the initial population or in step for the population at the preceding generation, certain individuals are selected to undergo the genetic transformations of reproduction. In one selection method, individuals are probabilistically selected for reproduction based on their relative fitness with respect to the total fitness of the population, individuals of higher fitness being more likely to be selected for reproduction than individuals of lower fitness. In another selection method, individuals are probabilistically selected based on fitness rank within the entire population (rank-based selection), or on fitness rank within a random sample of the population (tournament selection). In a further alternative, the more fit individuals in the population are selected (elitist selection). In a simple alternative method, all individual in a population reproduce. Thus, population represents a population at step X before the next step of iteration with the individuals selected for reproduction in this step, for example, c^{x}₁, and c^{x}_{N}, represented in a larger font and/or italic.

Next, in second step, the genetic operations are performed on the selected individuals to form new individuals which are added to population to form intermediate population. The genetic operators, to be further described below, include “mutation,” in which part of the chromosomal data is randomly changed, and “crossover,” in which portions of the chromosomes of two individuals are exchanged. The frequencies of mutation and crossover, and how individuals are chosen for crossover, and whether or not parents are retained in the population along with their offspring are further important EA parameters.

Preferably, the genetic operations contemplated do not mutate and assort separate components of reactant molecules and portions of reactions. Instead, such variations are accommodated by supplementing appropriately the initially selected reactants and reactions. Therefore, the eⁱⱼ and the rⁱⱼ, denoting reactants and reactions respectively, are indivisible representations of their represented reactions.

In third step, the fitness of all the new individuals in intermediate population is determined by applying the fitness (or objective) functions previously described to the product compounds. Fitness vector includes the fitness of all new individuals along with the fitness of individuals in population which have may already been determined in a previous step. Intermediate population includes the same individuals as intermediate population.

As part of this step, survivor, or most-fit, list is maintained. This list record the several (for example, 10 to 50) most fit individuals discovered to this point in the search. Each list element includes the chromosome, c^{x}ₖ, defining the individual, the most fit product, pᵢ(rⱼ) of the virtual reactions represented by this chromosome, and the fitness, f^{k}ₓ, of this product. In the preferred representation, each chromosome contains the full descriptions of a set of virtual reactions constructing a set of products.

In step, the last step, the individuals that will comprise succeeding population at step X+1 are determined, ordinarily according to one of two methods. In generational reproduction, each new individual created by the second step competes only with its parent (mutation) or its parents (crossing over) for selection into next generation. The winner(s) of this competition may be randomly selected, or alternately the winner(s) may be selected to be the most fit, whether parent or offspring (elitist selection). In steady-state reproduction, every individual competes against all individuals, parents, or offspring, or those individual not reproducing, for selection into next generation. This competition may be according to a selection probability increasing with fitness, or according to fitness rank, the N most fit being selected, or according to other methods known in the art.

Initial population may be selected by randomly assigning particular reactants (or educts) and reactions from the subsets of reactants and reactions selected to define the compound search space. Alternately, a user by applying chemical knowledge and intuition, may select those reactants and reactions estimated to be likely to lead to desired compounds.

### Genetic Operations, Data Structures, and Implementation

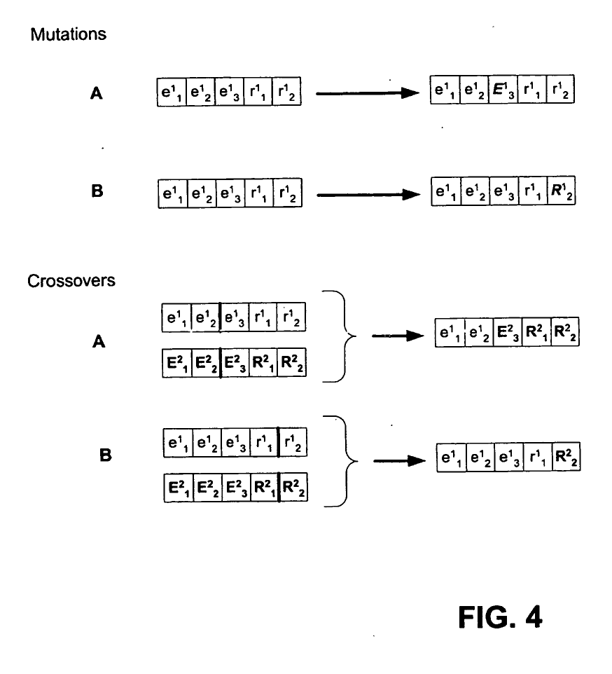

A variety of genetic operations are known in the art. See, e.g., Michalewicz. In fact, any genetic operations applicable to chromosomes composed of lists of indivisible genes are may be applied in the present invention. However, it has been found that the types of operations illustrated in FIG. 4 are sufficient for most purposes (although not limiting).

Three types of mutations that may be made on a randomly selected chromosome are illustrated. Type A mutations randomly select a particular reactant, e.¹₃, and replace it with another possible, randomly-selected reactant, E¹₃. Type B mutation similarly replace a particular, r¹₂, randomly-selected reaction with another randomly selected reaction, R¹₂. Type C mutations permute the reaction order; a further mutation type (not illustrated) may permute reactant order. The distributions by which random selection is made and the parameters of these distributions are important parameters of the invention. Those skilled in the art will recognize that other mutation methods are possible.

Two types of crossovers that may be made on a randomly selected pair of chromosomes are illustrated. Generally, crossovers are preferably created by replacing one or more genes in one chromosome of generation X with one or more genes from another chromosome of generation X, and vice versa. These exchanges are performed with a pre-set probability (e.g., 50%). Type D crossovers exchange reactants between two chromosomes, while type E crossovers exchange reactions between two chromosomes. It has been found that crossovers that exchange both reactants and reactions between selected chromosomes, although possible, are less preferable. Those skilled in the art will also recognize that other crossover methods would also work here. We have used many, but have not found that one works substantively better than others.

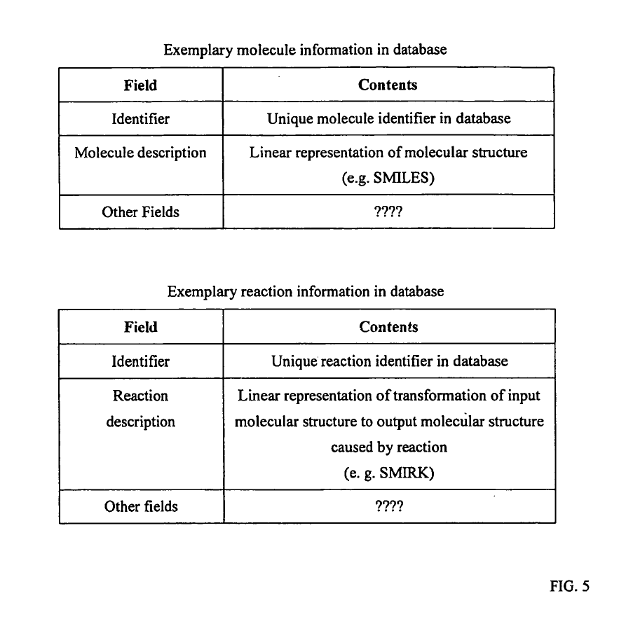

Next, FIG. 5 depicts exemplary data structures for practicing the preferred embodiment of the present invention. Each compound available as a reactant in the present invention may be represented by a record including, for example, a unique identifier (preferably fixed-length such as an integer) for the compound along with a representation of the compound as a linear string. The syntax of the string is preferably defined by SMILES. Although the string representation may be complete, this record advantageously also includes: molecular descriptors and similarity parameters, as known in the art, that permit efficient substructure and similarity searching; information on the sources and availability of the compound, literature references (including toxicity's) and standardized and conventional names; and other fields that may needed for particular functions. Also, the compound record may include indications of the sources of this compound, its availability, price, and other commercial information.

Additionally, each reaction available for simulation in the present invention may be represented by a record including a unique identifier along with a representation of the reaction transformation as a linear string with a syntax defined by, preferably, SMIRK and SMILES. As for compounds, this record may also include: descriptors and similarity parameters which can simplify retrieving reactions of particular characteristics; literature references and name, and the like. Also, further reaction specific information may be advantageous including for example: product yields; conditions and requirements; kinetics; subsidiary conditions on reactants; parameters for models representing additional physical features; and the like.

The unique compound and reaction identifiers may be used to identify reactants and reactions in the chromosomes discussed above. Also, this invention preferably includes communication means for querying chemical-reaction and reactant databases, compound property databases, and so forth.

Finally, because EAs operate on populations of semi-independent individuals, they offer many opportunities for parallelization known in the art. See, e.g., Erick Cantu-Paz, Efficient and accurate parallel genetic algorithms (Kluwer Academic 2000), and Schmeck et al., Parallel implementations of evolutionary algorithms, in Solutions to Parallel and Distributed Computing Problems 47-68 (Zomaya et al. eds., Wiley 2001). In particular, in one parallelization technique the population selection step is performed on one processor, while pairs of individuals are distributed to other processors for genetic alteration and fitness evaluation. In a further technique, the population is divided into a number of “sub-populations.” that are assigned to separate processors where they reproduce independently, except for occasional exchanges of individuals between neighboring sub-populations. In another known parallelization technique, a spatial distribution is defined on all the individuals in the population, and selection is restricted to only those individuals in a local neighborhood. This technique is suited to a highly parallel single instruction stream, multiple data stream computer, with each individual being assigned its own processor.

These and other techniques are advantageously employed in the present invention. However, at least it is advantageous to perform fitness determinations for different individuals in parallel. These fitness determination are typically expected to be computer-intensive, especially where fitness involves binding affinity and product structures need to be determined and evaluated.

### 5.2 Systems

The methods of this invention are preferably implemented by as a program(s) run on a computer system. The program may be written in and compiled from a convenient computer language or languages, such as, for example, C, LISP, PERL, C++, PROLOG, and the like. Advantageously, these programs may refer to other programs and program libraries that are available for representing reactants and reactions, e.g., the programs and libraries available from Daylight Chemical Systems, Inc., as well as further programs and libraries that are available from determining various fitness functions, e.g., the CLOGP program, the DOCK program, and the like.

Preferably, the programs of this invention communicate with a user for control and monitoring by means of graphical user interfaces (GUIs) such as are routinely available in the UNIX and LINUX operating systems, and in the WINDOWS family of operating systems.

Further, the programs of the present invention may be provided as a program product including one or more computer-readable media including such programs preferably in executable form. The media may be a floppy disk, a hard disk, a CD ROM, a flash memory card, a PROM, a RAM, a ROM, a magnetic tape, or by a network download process, all such media generically illustrated as article. Programs are loaded from such media into memory for execution by a computer system.

In one alternative, the programs of this invention may be executed on standard workstation type computer system (for example, after being loaded from media) with attached user interface equipment. Workstation preferably communicates with local or remote databases that store records representing available reactants and possible reactions.

In another alternative, the programs of this invention may be structured to perform computations in parallel, for example, to perform at least fitness determinations in parallel for the individuals in a generation. In this case, it is preferable that a plurality of computers, such as workstations type computers, communicatively interconnected, for example by local on long-distance network, with workstation all cooperate on executing the programs of this invention.

### 5.3 Preferred Embodiments

Generally preferred embodiments of the systems and methods of the present invention have been described above. In this subsection, further more particular, preferred embodiments are described which have been found to be particular advantageous. Accordingly, described herein are preferred classes of reactions (and reactants) and preferred user interface structures.

### Preferred Reaction Types

Generally, preferred types of reactions to use in constructing chemical search spaces are those that proceed substantially to completion. Substantial completion according to the present invention means that a reaction produces product in such relative quantities to prevent un-reacted reactants from remaining among the reaction products. Such un-reacted products can complicate search space construction by leading to an excessively rapid, even exponential, accumulation of simulated products. Specifically, a reaction proceed to substantial completion when the expected reaction products comprise, less preferably, 80%, or, more preferably, 90%, or even more preferably, 95% or more of the total reaction products.

In one alternative, a preferred reaction may proceed to effectively substantial completion because intended products are removed, for example, by solid state techniques, or by-products are removed, for example, by other separation means. In another alternative, a preferred reaction may proceed to substantial completion because of its thermodynamic or kinetic properties, for example, because it is significantly exothermic (compared to the temperature of the reaction environment).

More preferable are reactions that not only proceed to substantial completion but that lead to products of increased diversity so as to more rapidly construct the chemical search space. One class of such reactions are irreversible multi-component reactions (MCR) that convert three or more reactants into products including portions of all the input reactants. MCR product diversity is greater than that of standard two-component reactions because of the additional diversity provided by the third, fourth, or additional reactants. Irreversibility may be due to an exothermic ring-closure, or aromatization, or the like.

Even more preferably are irreversible MCRs utilizing isocyanides, which are driver by the exothermic conversion of C^{II} to C^{IV}. Such reactions types include Mannich three-component reactions, Asinger four-component reactions, Pictet-Spengler two-component reactions, Ugi four-component reactions, Passerini three-component reactions, Bucherer-Bergs four-component reactions, Ugi-Mannich five-component reactions, Gewald three-component reactions, and so forth as known in the art. Not only do these irreversible reactions lead to diverse products, but by appropriate choice of reactants (for example, aldehydes, alcohols, amides), the products are substantially drug-like and suitable as lead compounds. See, generally, Dömling et al., 2000, Agnew. Chem. Int. Ed. 39:3168.

In more detail, MCRs which produce one predominant product from generally three or more reactants, are preferable. MCRs using primary or secondary amine, carboxylic acid and isonitrile reactants almost exclusively produce α-amino acid amides in relatively high yield. Accordingly, these MCRs are particularly preferred for the production of α-amino acid amides.

### Preferred Program Structure

This sub-section describes an embodiment of the present invention which uses constructive search-space definitions based on syntactic reaction representations and genetic algorithms to control the search process. It is implemented as preferred with graphical user interfaces for setting up a particular problem, for tracking search progress, and for displaying results.

A preliminary step in a preferred method embodiment of the present invention is to define a pool of chemical compounds to be used as starting materials for a virtual synthesis software module. Preferably, software performing the preferred method is capable of reading a plurality of databases, such as: (1) Available Chemicals Directory™(MDL Information Systems Inc.) a commercially-available database of commercially-available chemical compounds; (2) an in-house corporate database of all stored compounds; and (3) special databases—e.g., databases of fine chemical suppliers.

The user of preferred software is preferably free to query all accessible databases for structures that may be interesting as starting material or to select whole compound classes B e.g., all available aldehydes, oxocomponents, etc. In this starting component setup, the user defines the number of starting component groups and their content, to define the first section of a chromosome that will be used in a genetic-algorithm-based search.

An exemplary user selection might comprise: (a) Gene 1 (starting component group) contains all aldehydes from the database environment; (b) Gene 2 contains all amines from the database environment; (c) Gene 3 contains all acids from the database environment; (d) Gene 4 contains all isocyanides from the database environment; and (e) Gene 5 contains all ketones from the database environment.

A preferred interface enables a user to perform a starting compounds selection step. In the second part of a preferred setup procedure a user defines a number of ‘reaction genes’. These reaction genes comprise virtual chemical reactions from a reaction database that contains reactions coded in e.g. SMILES (from Daylight software; see above), a reaction ID, virtual reactions coded in e.g. SMIRKS (Daylight), a short description, literature, data, and a reaction category (to help the user make a selection). With this reaction database in the background, a multi-step reaction scheme can be designed. An exemplary scheme is: (a) Gene 1 (reaction group) contains all chemical standard reactions in the database; (b) Gene 2 contains a subset of all known Multi Component Reactions; and (c) Gene 3 contains de-protecting reactions.

A preferred interface enables a user to perform a virtual reaction selection step. After selecting starting compounds and virtual reactions, a user has defined a chromosome that represents most, and perhaps all, available chemical structures that can be synthesized from the selected starting compounds and the sequentially-performed selected virtual reactions.

The next step in a preferred embodiment comprises setting virtual reaction parameters B for example, setting the depth of the virtual reaction. Polymerization products, if possible, are avoided with the parameter ‘polydepth’ (the number of iterations of one reaction).

A preferred interface enables a user to perform a virtual reaction parameter-setting step as described above. A ‘Save best’ entry box accepts a user-set size limit to a list of products with the best fitness function values (see below). A ‘Max polydepth’ entry box accepts a user-set limit to the number of times a virtual reaction is applied to a pot.

The next preliminary step in a preferred method embodiment is to define fitness parameters. Virtual products from a preferred evolutionary method (genetic algorithm) are preferably scored against one or more fitness criteria. Selected fitness criteria represent the vision of the user about the desired structure or molecular properties of a chemical product to be searched for. Preferably, known software modules that calculate molecular properties out of chemical structures, compare structures in 2D or 3D, or apply a docking computation to estimate affinity to biomolecules can be used in a preferred software embodiment. Several fitness functions, listed below are typically implemented.

2D-Similarity fingerprints: This module compares the user-defined structure with the products of the virtual reactions on the basis of common 2D-substructures. Based on the comparison of the two fingerprints of the molecules, a similarity is calculated. This similarity represents the value of the virtual products, and is used as a fitness of the chromosome (starting components and reaction sets) for the evolutionary process of a preferred genetic algorithm.

3D-Similarity: The comparison of the shape and/or charge distribution on the surface of a user-defined target molecule with the products of the virtual reaction results in a 3D-similarity value, which can be used as a fitness value for the evolutionary process.

Docking process: With the definition of an enzyme, receptor, or other target, a 3-dimensional structure is calculated from the 2-dimensional representation passed to a docking module, which calculates the binding parameters to a larger biomolecule (enzyme, etc.). The result is used as the fitness value of the chromosome.

Polar surface area: The polar surface area of a molecule is calculated. The user can define the range of the polar surface area he wants to have in his virtual product.

Clogp: The partition octanol/water coefficient is calculated from the structure. This fitness criterion can be set to search for the synthesis of products in a specific range, which may ensure a better change of bioavailabilty.

Rotatable bonds, acceptors, donors: All rotatable bonds in the vitual products are counted. The user can define the range of rotatable bond which have to be in the products. The numbers of H-Donors or H-Acceptors within the virtual product can be defined as a target function as well.

Molweight: This function returns the molecular weight of a compound.

Charge: A charge or non-charge can be defined as a requirement for the virtual product.

Fitness criteria are preferably normalized, to give a result between 0 and 1. 1 is only reached when the virtual products fulfill the users requirements. Fitness functions can preferably be combined and weighted to build up a more complex query and to define a combined fitness measure as a goal for the evolutionary process.

A preferred interface for enabling a user to perform a fitness function definition/selection step. A ‘Property name’ column lists fitness parameters available to a user. Each parameter can be selected by checking an adjacent check-box. A ‘Weight [%]’ column displays weights that have been assigned by the user to the selected parameters. A weight can be assigned to each parameter using an appropriate entry box as shown in the lower portion of the display.

A ‘Property’ column displays a fitness function property for a selected parameter. A preferred interface contains ‘Min’ and ‘Max’ columns, as well as ‘Gradient<min’ and ‘Gradient>max’ columns, display values of ranges set for selected parameters. The gradient values relate to Gaussian distributions with values that lie outside, but near, minima and maxima.

In a final setup step of a preferred embodiment, general parameters for the genetic algorithm are set. An ‘n runs’ entry enables a user to set the number of times the search is repeated. A ‘Population Size’ entry enables a user to set a maximum size for the number of members of each generation. A ‘Max Generations’ entry enables a user to set the maximum number of generations that will be searched.

A ‘X-Over genom [%]’ entry enables a user to set the frequency with which educt crossovers occur. A ‘X-over codon [%]’ fesature enables a user to set the frequency with which reaction crossovers occur. A ‘Mutation genom [%]’ entry box enables a user to set the frequency with which educt mutations occur. ‘Mutation codon [%]’ can also be set by a user to set the frequency with which reaction mutations occur.

For displaying to a user in real-time the progress made toward finding an optimal solution set (i.e., the ‘learning’ progress of the method). A top, set-shaped curve shall depict, over an increasing number of populations, the fitness function value of the chromosome with the highest fitness value found so far. Another curve shall depict the fitness function of the chromosome with the lowest fitness function value that is currently stored. This curve will increase, due to the ‘evolutionary’ nature of the genetic algorithm and a limited population size. The resulting selection pressure tends to insure that chromosomes have an increasing minimum, average, and maximum fitness over time.

### 5.4 Additional Embodiments

This section describes details of two additional embodiments of the present invention. The first additional embodiment is directed to finding one or more small molecules (ligands) which bind to a larger binding molecule (the receptor). Here, fitness values are chosen to depend largely or exclusively on an estimate or an indicia of the binding affinity or energy of the ligand to the receptor. The binding affinity or free energy is advantageously predicted by a molecular docking program (or similar), which, using the three dimensional structures of the ligand and receptor, searches for a fit between the ligand and receptor (for example, at a binding region or in a binding pocket) that has a maximum affinity or a maximum binding free energy (possibly a local maximum or a near maximum), and then returning the discovered maximum as the predicted affinity or energy. The docking program computes the affinity or energy of a candidate fit according to a molecular scoring function preferably combining energetic with entropic (including solvent) effects.

In more detail, docking programs useful in this invention may by roughly classified according to the approximations used to search for the ligand-receptor fit. A simple but computationally rapid approximation treats the ligand and receptor as rigid bodies without conformational changes upon binding. See, e.g., Kuntz at al. 1982, J. of Mol. Biol. 161:269. With increasing accuracy, conformational changes of the ligand upon binding may be treated by means of Monte Carlo and/or simulated annealing methods, genetic algorithms or distance geometry. See e.g., Goodsell et al., 1990, Proteins: Structure, Function, and Genetics 8:195; Oshiro et al., 1995, J. of Comp.-Aided Mol. Design 9:113. Ligand conformation change may also be treated by incremental construction of the ligand bound to the receptor. See, e.g., Leach et al., 1990, J. of Comp. Chem. 13:730; Rarey et al., 1996, J. of Mol. Biol. 261:470. Finally, with sufficient computational resources, conformation changes of the receptor itself may be treated, for example, by allowing flexibility of protein side chains. See, e.g., Leach, 1994, J. of Mol. Biol. 235:345. Similarly, the scoring functions may be roughly classified according to their type or degree of approximation. Most scoring functions treat the free energy of binding as a sum of terms representing solvent effects, entropy changes between the unbound and the bound states, and the specific intermolecular interaction energies. See, e.g., Bohm et al, 1996, Angwandte Chemie Int'l. Ed. in Eng. 34:2588. These terms may be linearly approximately with coefficients determined by linear regression from experimental data. See, e.g., Bohm, 1994, J. of Comp.-Aided Mol. Design 8:243. The molecular interaction energies may be approximated by molecular mechanics methods, perhaps where the spatial receptor force field is precomputed. See, e.g., Meng et al., 1992, J. of Comp. Chem. 13:505.

In view of the above, for a particular problem and with known computational resources available, one of skill in the art will be able to select for use in this invention appropriate approximations of sufficient accuracy and suitable computational demands. A docking program meeting these requirements may then either be written or selected from publicly available sources.

Before a docking program can be executed, the three-dimensional structures of the ligand and receptor are needed. In preferred implementations, the systems and methods of this invention use linear representations of reactants, which may be readily converted to 3D structures by a number of methods. For example, if the reactant happens to already be in a database of 3D chemical structures, database lookup will retrieve the needed structure. Preferably, and necessarily for unknown reactants, the linear structure may be converted into 3D conformations by one of the many calculation techniques known in the art, for example, by (ab initio) quantum mechanics, or by molecular dynamics or Monte Carlo techniques using an empirical molecular force function, or by geometric and other conformational techniques. See, generally, Leach, 2001, Molecular Modeling Principles and Applications Second Edition, Pearson Education Ltd., Harlow, England. In alternate embodiments, the methods of this invention may work directly with 3D structures, and separate conversion will be needed. The 3D structure of the receptor, which in most applications will be a protein, may be obtained by well known protein structure determination techniques, for example, X-ray diffraction, or neutron diffraction, or nuclear magnetic resonance (NMR).

A fitness function depending on a selected docking program that docks ligands to a predetermined receptor may then be employed in the systems and methods of this invention as already described. These methods proceed to explore a defined chemical structure space by carrying out simulated reactions. The fitness of the products of the simulated reactions are then evaluated by, first, converting the products to 3D conformations (or a set of possible conformations), and then evaluating the binding to the receptor by applying the docking program. The fitness values obtained guide the genetic search methods, as previously described, until a set of sufficiently optimized ligands (for example, the docking program indicating an affinity of, less than 100 μm. or less than 10 μm., or less than 1 μm, or less than 0.1 μm) is discovered.

Optionally, the discovered ligands may by synthesized (preferably according to the reactions simulated for their discovery) and their actual binding to the receptor tested. Physical binding of ligand and receptor may be measured by numerous techniques well known in the art, for example, by micro-calorimetry. See, generally, Fersht, 1999, Structure and Mechanism in Protein Science, W.H. Freeman and Co., New York. Alternately, where available, a biological assay for the biological effect of ligand-receptor binding may be used to assay the discovered ligands for potential pharmacological applications.

Next, in the second additional embodiment, the systems performing the methods of the present invention are coupled, directly or indirectly, to laboratory automation systems such as are known in the art. For a particular problem, the laboratory systems, perhaps including laboratory robots, are configured to be capable of performing the synthetic reactions simulated by the invention's methods to discover products, and preferably also of carrying out assays, for example binding affinity assays, on the synthesized reaction products. In more detail, the laboratory systems and robots preferably, and with minimal of no manual intervention, retrieve specified reactants, combine the reactants and perform the simulated reactions, carry out post-reaction separations and so forth, if any, prior to assay, transport the synthesized products to assay devices, perform the assays, and then be ready to repeat this cycle for further synthetic reactions. Such a laboratory automation capability permits the results of the assays to be used by this invention's as the actual fitness functions to guide the choice of next reactions to simulate.

The automated assays may involve measurement of physico-chemical parameters of the products. For example, micro-calorimetric equipment can measure affinities with little intervention. Other physico-chemical properties of the products that can be automatically assayed may include index of refraction, infrared spectra, ultraviolet spectra, NMR spectra, chromatographic separations, and the like. Also, the automated assays may measure biological properties of the products. For example, in vitro enzyme assays, in vivo or cellular assays, or a combination of, in vitro and in vivo assays may measure biological activity, selectivity, or an activity/selectivity profile. Results of biological assays may be read by, for example, reusable micro-arrays of nucleic acids or proteins.

Fitness functions depending on the results of actual physico-chemical or biological assays allows the present methods uniquely to discover optimized output products of immediately proved properties. However, to more efficiently use available laboratory automation equipment and robots, it may be advantageous to initially search chemical space using entirely in silico methods. Later, initial products found to be promising, for example, by having a docking program indicate an attractive affinity for a receptor, may be further optimized by use of a fitness function that depends on actual assay results.

### 6. EXAMPLES

This section describes an application of the preferred embodiment of the invention used to search for a new synthesis of a known compound, lidocaine.

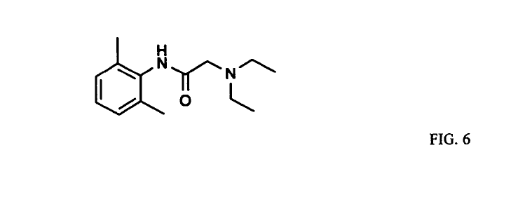

Lidocaine is a well-known local anesthetic that can be synthesized via a multi-component reaction. In the example described below, the preferred method is used to search for a method of synthesis for the lidocaine structure (shown in FIG. 6) or for synthesis of a compounds with similar structures that can be synthesized via multi-component reactions of various types.

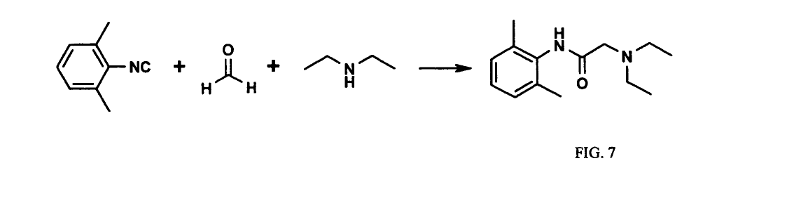

Starting component setup: a preferred setup was performed. The setup included over 12 possible multi-component reactions (MCRs). FIG. 7 illustrates an exemplary Ugi three component reaction (3-CR).

A starting set of 4 different starting compound classes was loaded with different substances selected from the Available Chemicals Directory (Available Chemicals Directory™), a commercially available database of chemical compounds. This database presently contains 237,605 chemical structures and their suppliers. See, e.g., Daylight Chemical Information Systems, Inc. (http://www.daylight.com/products/databases/ACD).

The first starting component gene (named e1) was loaded with structures containing an aldehyde function. There 3400 chemical structures in the database which contain one or more aldehyde functions. The second gene (e2) was loaded with 15,264 primary and secondary amines. The third gene (e3) represents list of 24,951 carboxylic-acid-containing compounds. The fourth gene (e4) is loaded with a set of isocyanides, 32 commercially-available isocyanides combined with locally available isocyanides. To select the starting compound list for every gene, a substructure search was performed within the ACD database with the queries shown in Table 1. To effectively search a daylight database, a SMART query may be executed. (The SMART and SMILES software packages use syntactic representations and are described above.)

TABLE 1

| | | Number | |
|---|---|---|---|
| | Substructure | retrieved | SMART query |
| Gene 1 | ALDEHYDE | 3400 | [C;$(C=[O;D1;$(O═C)]);H1,H2] |
| Gene 2 | SECONDARY_{—} | 15,264 | [N;!$(N*=[!#6]);!$(N˜[!#6]);!$(Na);!$(N#C);!$ |
| | AMINE | | (N═C);D2] |
| | PRIMARY_{—} | | [N;!$(N*=[!#6]);!$(N˜[!#6]);!$(Na);!$(N#C);!$ |
| | AMINE | | (N═C);D1] |
| Gene 3 | CARBOXYLIC_{—} | 24,951 | C;$(C=[O;D1;$(O═C)]);$(C[O;H1&−0,H0&−1]); |
| | ACID | | $(C[#6,#1])] |
| Gene 4 | ISOCYANIDE | 32 | [C,c][N+]#[C−] |

Reaction gene setup: to achieve the synthesis target with the selected compounds, a set of 12 multi-component reactions was chosen. For each selected MCR, the following list includes its name and description, its SMILES and SMIRK representations, and an estimate of the possible products with the chosen starting set of compounds.
1. A subtype of the Passerini-Reaction with water as acid-component
   O.*[N+]#[C−].*C(═O)*>>*NC(═O)C(*)(*)O
   [N+:7]#[C:8].[C,c,#1:60][C:4](═[O:20])[C,c,#1:61]>>[N:7][C:8](═O)[C:4]([C,c,#1:6 0])([C,c,#1:61])[O:20]
   (52,700 possible products)
2. A variation of the Ugi-Reaction: primary amines, aldehydes or ketones, isonitriles, and KSCN.
   *N.*[N+]#[C−].*C(═O)*.[S-]C#N>>*NC1=NC(═S)N(*)C1(*)* [C,c,#1:1][C:2]([H])═O.[C,c,#1;!$(C═[O,N,S]):3][N:4]([H])[H].[N+:5]#[C:6]>>[C,c, #1:3][N:4]1 [C:2]([H])([C,c,#1:1])[C:6](═[N:5])NC1(═S)
   (5,263,676,000 possible products)
3. A variation of the Ugi-Reaction with isonitrile, aldehyde or ketone, secondary amine, and azide salt.
   *N*.*[N+]#[C−].*C(═O)*.[N−]=[N+]=[N−]>>*N(*)C(*)(*)c1nnnn1* [N+:7]#[C:8].[C,c,#1:60][C:4](═O)[C,c,#1:61].[C,c;!$(C═[O,N,S]):1][N:2]([H])[C,c; !$(C═[O,N,S]):3]>>[N:7]1N═NN═[C:8]1[C:4]([C,c,#1:60])([C,c,#1:61])[N:2]([C,c:1])[C,c:3]
   (2,780,452,000 possible products)
4. Doebner Reaction with an a-oxo-acid (ester), aldehyde, and amine.
   *N.*C═O.*C(═O)C(═O)*>>*C1N(*)C(═O)C(═C1*)O
   [C,c,#1:1][N:10]([#1:5])[#1:6].[C,c,#1:2][C:14]([#1:7])([#1:8])[C:17](=[O:12])[C:18](═[O:13])[O:15][C,c,#1:3].[C,c,#1:4][C:16](═[O:11])[#1:9]>>[O:11]([#1:5])[#1:6].[C,c,#1:3][O:15][#1:7].[C,c,#1:4][C:16]1([#1:9])[N:10]([C,c,#1:1])[C:18](=[O:13])[C:17](═[C:14]1[C,c,#1:2])[O:12][#1:8]
   (1,901,715,200 possible products)
5. A variation of the Ugi-Reaction with an a-aminopyridine as amine component.
   *C═O.*[N+]#[C−].Nc1****n1>>O.*Nc1c(*)nc2****n12
   [#1:90][N:1]([#1:91])[c:2]1 [n:3][a:4][a:6][a:8][a:10]1.[C,c,#1:12][C:13]([#1:92])=[O:14].[C,c,#1:15][N+:16]#[C:17]>>[C,c,#1:12][C:13]1═[C:17]([N:16]([#1:90])[C,c,#1:15]) [n:3]([c:2]2═[N:1]1)[a:4][a:6][a:8][a:10]2.[#1:91][O:14][#1:92]
   (1,844,500,000 possible products)
6. Passerini reaction with aldehyde or ketone, isocyanide and acid.
   *[N+]#[C−].*C(═O)*.*C(═O)O>>*NC(═O(O)C(*)(*)OC(═O)*
   [N+:7]#[C:8].[C,c,#1:60][C:4](=[O:20])[C,c,#1:61].[C,c,#1:30][C:31](=[O:32])[O:33 ][#1:34]>>[N:7]([#1:34])[C:8](=[O:33))[C:4]([C,c,# 1:60])([C,c,#1:61])[0:20][C:31]( ═[O:32])[C,c,#1:30]
   (13,149,177,000 possible products)
7. A variation of the Ugi-Reaction with isonitrile, aldehyde or ketone, and azide salt.
   *[N+]#[C−].*C(═O)*. [N−]=[N+]=[N−]>>*n1nnnc1C(*)(*)O [N+:7]#[C−:8].[C,c,#1:60][C:4](=[O:20])[C,c,#1:61]>>[N:7]1N═NN═[C:8]1 [C:4]([C,c,#1:60])([C,c,#1:61])[O:20]
   (527,000 possible products)
8. A variation of Ugi-4CR-Reaction with amines, aldehydes or ketones, isonitriles, and KOCN.
   *N.*[N+]#[C−].*C(═O)*.[O−]C#N>>*NC1=NC(═O)N(*)C1(*)*
   [C,c,#1:1][C:2]([H])═O.[C,c,# 1;!$(C═[O,N,S]):3][N:4]([H])[H]. [N+:5]#[C:6]>>[C,c,#1:3]N:4]1 [C:2]([H])([C,c,#1:1])[C:6](=[N:5])NC1(═O)
   (5,263,676,000 possible products)
9. A variation of the Ugi-Reaction with water as acid component.
   *N*.*[N+]#[C−].*C(═O)*>>O.*NC(═O)C(*)(*)N(*)*
   [N+:7]#[C:8].[C,c,#1:0][C:4](═O)[C,c,#1:61]. [C,c,#1;!$(C═[O,N,S]):1][N:2]([H])[C,c,#1;!$(C═[O,N,S]):3]>>[N:7]([H])[C:8](═O)[C:4]([C,c,#1:60])([C,c,#1:61])[N:2]([C,c:1])[C,c:3]
   (8,044,128,000 possible products)
10. A variation of the Ugi-Reaction with a-aminopyrrole as amine-component.
   *C═O.*[N+]#[C−].Nc1***n1>>O.*Nc1c(*)nc2***n12
   [#1:90][N:1]([#1:91])[c:2]1 [n:3][a:4][a:8][a:10]1.[C,c,#1:12][C:13]([#1:92])=[O:14]. [C,c,#1:15][N+:16]#[C:17]>>[C,c,#1:12][C:13]1=[C:17]([N:16]([#1:90])[C,c,#1:15]) [n:3]([c:2]2=[N:1]1)[a:4][a:8][a:10]2.[#1:91][O:14][#1:92]
   (685,100,000 possible products)
11. A vanLeussen Reaction with optional amines, aldehydes, and special isocyanide.
   *N.*C═O.*C([N+]#[C−])S(═O)(═O)c1ccc(C)cc1>>*c1ncn(*)c1*
   c1cc(C)ccc1S(═O)(═O)[C:1]([H])([C,c,#1:2])[N+:3]#[C:4].[C,c,#1:5][C:6]([H])=[O]. [H][N:7]([H])([C,c,#1:8])>>[C,c,#1:8][N:7]1[C:6]([C,c,#1:5])=[C:1]([C,c,#1:2])[N:3]=[C:4]1 [H]
   (33,959,200 possible products)
12. An Ugi-Reaction with amines, aldehydes or ketones, acids, and isonitriles.
   *N.*[N+]#[C−].*C(═O)*.*C(═O)O>>*NC(═O)C(*)(*)N(*)C(═O)*
   [N+:7]#[C:8].[C,c,#1:60][C:4](═O)[C,c,#1:61].[C,c;!$(C═[O,N,S]):1][N:2]([H])[#1:99].[C:10](═[O:11])[O:12][H]>>[N:7]([#1:99])[C:8](=[O:12])[C:4]([C,c,#1:60])([C,c,#1:61])[N:2]([C,c:1])[C:10](═[O:11])
   (126,328,224,000,000 possible products)

The numbers of possible reaction products are estimated using the numbers of the individual selected starting component classes in Table 1.

Fitness: The structure of Lidocaine (see FIG. 11) was the input target for 2D-Similarity. The weight within the fitness was 100%. No other fitness criterion was chosen.

Virtual reaction properties: The number of iterations of the virtual reaction was set to 2, to avoid the production of bigger molecules. To avoid the creation of big molecules, the maximum length of a product smile was set at 500 (est. 300g/mol). Settings of the genetic algorithm: (a) Population size: 50; (b) maximum number of generations: 400; (c) runs of the GA: 1; (d) crossover probability per genome: 100%; (e) crossover probability per gene: 50%; and (f) mutation rate per genome: 20%. The codon of each gene (the on/off switch of genes) was deactivated. After 340 generations, the software method found the a way to synthesize Lidocaine (approximate runtime was 30 min).

The determined starting components were:
e1. formaldehyde with water (the typically-available form);
e2. starting component did not play a role in that reaction;
e3. mixture of diethylamine and acetic acid;
e4. 2,5 dimethylphenyl isocyanide; and
r1. A variation of the Ugi-Reaction with water as acid component

The best fitness eventually reaches 1 at about 330 generations, signifying that lidocaine has been synthesized.

In conclusion, the methods of the present invention correctly determined a synthesis of lidocaine by searching the defined search space with the guidance of a 2D similarity fitness function.

The invention described and claimed herein is not to be limited in scope by the preferred embodiments herein disclosed, since these embodiments are intended as illustrations of several aspects of the invention. Any equivalent embodiments are intended to be within the scope of this invention. Indeed, various modifications of the invention in addition to those shown and described herein will become apparent to those skilled in the art from the foregoing description. Such modifications are also intended to fall within the scope of the appended claims.

A number of references are cited herein, the entire disclosures of which are incorporated herein, in their entirety, by reference for all purposes. Further, none of these references, regardless of how characterized above, is admitted as prior to the invention of the subject matter claimed herein.

1. A method for planning the synthesis of one or more chemical compounds with specified chemical properties, comprising the steps of:
(a) representing a space of synthesis plans, wherein each synthesis plan in the space of synthesis plans represents one or more virtual reaction schemas applied to one or more classes of virtual input reactants;
(b) representing a space of virtual compounds, wherein each compound in the space of virtual compounds is a product of one or more of said synthesis plans;
(c) constructing a first mapping from the space of virtual compounds to a range space, wherein said first mapping is determined by one or more compound properties being measured; and
(d) searching the space of synthesis plans using the following steps:
(i) for a selected synthesis plan, simulating the synthesis represented by the plan to obtain one or more virtual compounds in the space of virtual compounds,
(ii) mapping the synthesis plan to the range space by applying a second mapping, wherein said second mapping is constructed by (a) mapping the synthesis plan to its products in the space of virtual compounds, then (b) mapping the products of the synthesis plan to the range space using the first mapping,
(iii) repeating steps (i) and (ii) until the second mapping applied to least one selected synthesis plan maps to a pre-determined subset of the range space.

2. A method as in claim 1, wherein said first mapping is a fitness function.

3. A method as in one of claim 1, wherein compounds are represented as virtual compounds.

4. A method as claim 1, wherein said step of searching the space of synthesis plans comprises a genetic algorithm search method.

5. A method as in claim 1, wherein the range space is a subset of the set of real numbers.

6. A method as in claim 1, wherein the range space is the interval [0,1].

7. A method of identifying chemical compounds with specified properties, comprising the steps of:
(a) defining a first generation of one or more chromosomes comprising one or more educts and one or more reactions;
(b) for each chromosome, sequentially virtually performing said reactions cyclically, first on the educts, then on resulting reaction products, until a predetermined event occurs;
(c) assigning one or more fitness function values to reaction products resulting from step (b); and
(d) assigning one or more fitness function values to each of said chromosomes, based on fitness function values assigned to reaction products in step (c).

8. A method as in claim 7, further comprising performing steps (b) through (d) on one or more subsequent generations of chromosomes, where each generation is derived from the preceding generation using genetic operations.

9. A method as in claims 7, further comprising creating and maintaining a list that comprises chromosomes with corresponding fitness function values, ranked according to the best value.

10. A method as in claim 9, further comprising replacing a chromosome on said list that has a worst value with a chromosome with a better value when such a better-valued chromosome is identified.
